(19) United States
(12) Patent Application Publication
(10) Pub. No.: US 2013/0230794 A1
(43) Pub. Date: Sep. 5, 2013

(54) COMPLEX OXIDES FOR CATALYTIC ELECTRODES

(71) Applicants: Sujit Kumar Mondal, Houston, TX (US); Jason S. Rugolo, Dorchester, MA (US); Brian Huskinson, Cambridge, MA (US); Michael J. Aziz, Concord, MA (US)

(72) Inventors: Sujit Kumar Mondal, Houston, TX (US); Jason S. Rugolo, Dorchester, MA (US); Brian Huskinson, Cambridge, MA (US); Michael J. Aziz, Concord, MA (US)

(73) Assignee: PRESIDENT AND FELLOWS OF HARVARD COLLEGE, Cambridge, MA (US)

(21) Appl. No.: 13/808,720

(22) PCT Filed: Jul. 8, 2011
(86) PCT No.: PCT/US11/43272

§ 371 Date: Apr. 26, 2013

Related U.S. Application Data
(60) Provisional application No. 61/362,675, filed on Jul. 8, 2010.

(51) Int. Cl. H01M 4/90

(52) U.S. Cl. CPC H01M 4/9016
USPC 429/526; 204/292

(57) ABSTRACT

A catalytic electrode may include a complex oxide deposited on a substrate. The complex oxide maybe an oxide of an alloy of ruthenium and another less expensive metal, including without limitation cobalt and manganese. The percentage of ruthenium in the complex oxide can be reduced to about 20 percent or less, while still allowing the electrode to maintain adequate electrocatalytic activity during redox reactions at the electrode. Electrodes can be synthesized using RuCo oxides with ruthenium content reduced to about 5%, or using RuMn oxides having ruthenium content reduced to about 10%, while maintaining good catalytic activity. These electrodes may be used in electrochemical cells including without limitation fuel cells, flow batteries and regenerative fuel cells such as halogen fuel cells or hydrogen-halogen fuel cells. These electrodes may also be used in electrolytic cells.

### CROSS-REFERENCE TO RELATED APPLICATIONS

The present application is based upon, and claims the benefit of priority under 35 U.S.C. §119, to co-pending U.S. Provisional Patent Application No. 61/362,675 (the “'675 provisional application”), filed Jul. 8, 2010 and entitled “Complex Oxides For Catalytic Electrodes.” The content of the '675 provisional application is incorporated herein by reference in its entirety as though fully set forth.

STATEMENT REGARDING FEDERALLY SPONSORED RESEARCH

This invention was made with government support under grant IIP-0848366 awarded by the National Science Foundation. The government has certain rights in the invention.

### BACKGROUND

While many systems of storing electrical energy are known, only a few have adequate power levels, cost efficiency, and energy storage capacities required to support large scale renewable electrical energy production and use. Examples include without limitation flow batteries or regenerative fuel cells that involve hydrogen-halogen and zinc bromine chemistries. Making low cost, high performance and durable electrodes is essential for the success of the technology.

A widely used catalyst for halide oxidation is an anode commonly referred to as a “Dimensionally Stabilized Anode”, or DSA. DSAs are electrodes that have coatings based on mixed ruthenium and titanium oxides, i.e. are electronically conducting mixtures of RuO₂ (ruthenium dioxide) and TiO₂ (titanium dioxide).

A typical DSA usually contains at least 30 mole-percent of RuO₂, however. Since precious metals such as Ru (ruthenium) are very expensive, DSAs are an expensive electrode choice for use in an electricity storage technology.

Accordingly, there is a need for methods and systems that can reduce the ruthenium loading in catalytic electrodes without significantly compromising their electrocatalytic activity and other desirable properties.

### BRIEF DESCRIPTION OF THE DRAWINGS

The drawings disclose illustrative embodiments. They do not set forth all embodiments. Other embodiments may be used in addition or instead.

FIG. 1 is a schematic block diagram of a catalytic electrode, in accordance with one embodiment of the present disclosure.

FIG. 2A illustrates half-cell measurements of the electrocatalytic activity of some alloy oxide electrodes for chloride oxidation.

FIG. 2B illustrates half-cell measurements of the electrocatalytic activity of some alloy oxide electrodes for bromide oxidation.

FIG. 3A illustrates half-cell measurements of electrode activity for a number of Ru-metal alloy oxides.

FIG. 3B illustrates half-cell measurements of electrode activity for Ru—Co alloy oxides, for different Ru concentrations.

FIG. 4A is a schematic block diagram of the charge (i.e. electrolytic) mode of a hydrogen-chlorine regenerative fuel cell that includes a catalytic electrode synthesized using an alloy oxide in accordance with some embodiments of the present disclosure.

FIG. 4B is a schematic block diagram of the discharge (i.e. galvanic) mode of a hydrogen-chlorine regenerative fuel cell that includes a catalytic electrode synthesized using an alloy oxide in accordance with some embodiments of the present disclosure.

FIG. 5A illustrates H₂/Cl₂ fuel cell measurements over a current density range from 0 to about 150 mA/cm².

FIG. 5B illustrates H₂/Cl₂ fuel cell measurements over a current density range from 0 to about 650 mA/cm².

### DETAILED DESCRIPTION

The present disclosure describes complex oxides which can be used as catalysts for redox reactions, with a considerably reduced ruthenium content. A number of complex oxides are disclosed that were found to be potent catalysts, stable, and to have good electrical conductivity, while having a significantly reduced ruthenium content compared to conventional oxide electrodes. These complex oxides can be implemented with a significantly lower cost due to greatly reduced precious metal content.

Modern electrodes for the oxidation of halide ions are based on DeNora's DSAs, which is an oxide of a RuₓTi₁₋ₓ alloy, with x typically >30%. A description of DSAs can be found for example in T. V. Bommaraju, C.-P. Chen, and V. I. Birss, “Deactivation of Thermally Formed RuO₂+TiO₂ Coatings During Chlorine Evolution: Mechanisms and Reactivation Measures,” in Modern Chlor-Alkali Technology, Volume 8, edited by J. Moorhouse (Blackwell Science, Ltd., London, 2001), p. 57. The contents of this reference are incorporated herein by reference in its entirety.

In the present disclosure, the term “regenerative fuel cell” means an energy storage device that operates in steady state so that the chemical activities of the reactants and of the products are steady over time during charging and during discharging. Subtypes of regenerative fuel cells include, without limitation, hydrogen fuel cells and hydrogen-halogen fuel cells.

In the present disclosure, the term “flow battery” means an energy storage device in which the chemical activities of the reactants and of the products change with time during charging and during discharging.

It is to be understood that the inventive subject matter in the present disclosure is not limited to the particular embodiments described below, as such may vary. It is also to be understood that the terminology used herein is for the purpose of describing particular embodiments only and is not intended to be limiting, since the scope of the inventive subject matter will be limited only by the appended claims. Unless defined otherwise, all technical and scientific terms used herein have the same meaning as commonly understood by one of ordinary skill in the art to which the inventive subject matter belongs.

Although any methods and materials similar or equivalent to those described herein can also be used in the practice or testing of the inventive subject matter disclosed below, a limited number of the exemplary methods and materials are described.

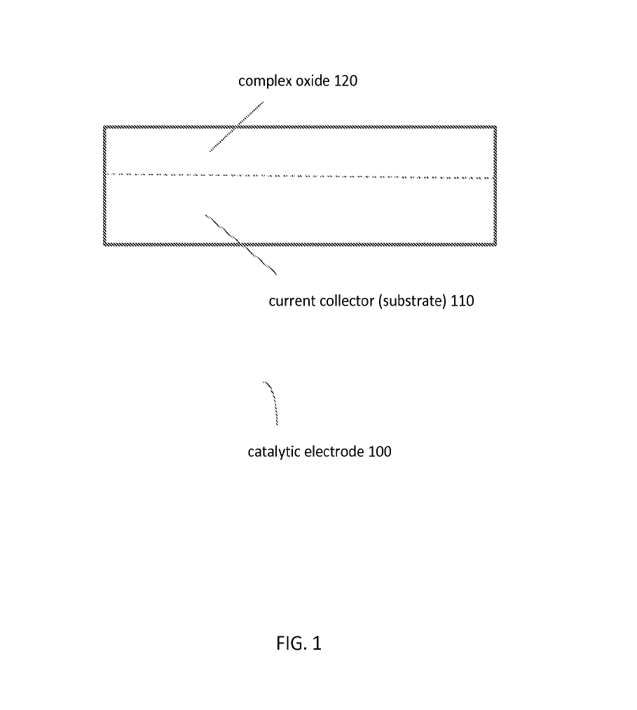

FIG. 1 is a schematic block diagram of a catalytic electrode 100, in accordance with one embodiment of the present disclosure. The catalytic electrode includes a current collector 110, and one or more layers of electronically conducting complex oxide 120 deposited on the current collector 110. The current collector 110 is a substrate, for example a titanium substrate or a niobium substrate.

The complex oxide 120 includes Ru, oxygen (O), and at least one other metal. In the illustrated embodiment, the percentage of the metal content that is ruthenium is less than about 20 atomic percent. The ruthenium percentage, as well as the other metal, are selected so as to allow the electrode to maintain sufficient electrocatalytic activity in electrochemical redox reactions at the electrode.

The complex oxide may be an alloy oxide, a composite oxide, or combinations thereof. The complex oxide may also be multi-phase mixtures of alloy oxides or composite oxides.

In some embodiments, the complex oxide is a metal alloy oxide that contains ruthenium. In these embodiments, the alloy oxide is an oxide of an alloy that includes ruthenium and a metal other than ruthenium, i.e. the alloy oxide is an oxide of a RuₓM₁₋ₓ alloy, where M represents a metal other than ruthenium. In some embodiments, M may be a transition metal. Typically, M is much more cost effective, compared to Ru.

In some embodiments, the catalytic electrode is an anode at which oxidation reactions occur. For example, in hydrogen-halogen fuel cells the above-described alloy oxides may be useful as cost-effective anodes that can catalyze halide oxidations, such as the oxidation of chloride to chlorine and the oxidation of bromide to bromine.

In other embodiments, the catalytic electrode is a cathode at which reduction reactions occur. In hydrogen-halogen fuel cells, the above-described alloy oxides may be useful as cost-effective cathodes that can catalyze electrochemical halogen reductions, such as the reduction of halogen to halide ions.

In some embodiments, the complex oxide and the electrode are nano-structured.

In some embodiments, the substrate has a thickness less than about 150 microns. It is contemplated that the substrate 110 can have any desired or appropriate thickness, size and composition, which are merely design parameters.

In some embodiments, the complex oxide may be a single-phase alloy oxide, where the alloy may include ruthenium and another metal. In other embodiments, the complex oxide may be a composite of multiple phases, in which each constituent phase is a metal oxide or an alloy oxide.

The catalytic electrode 100 may be fabricated using any suitable known method. In some embodiments, alloy oxides with low precious metal percentages were prepared on titanium substrates at Harvard University, using traditional wet chemical synthesis methods for fabricating commercial DSAs. In overview, these wet chemical synthesis methods involve dissolving salts of ruthenium and the above metals in an aqueous acid or acid-alcohol mixture, coating the substrate, heating to evaporate the solvent, then baking at high temperature during each sequence of the coating.

Further details regarding these synthesis steps as known in the chlor-alkali industry may be found for example in “Modern Chlor-Alkali Technology Volume 8,” John Moorhouse Ed., Proceedings of the 200 London International Chlorine Symposium, May 31-Jun. 2, 2000. The contents of this reference are incorporated herein by reference in their entirety.

Alloy oxides including Ru and a number of metals have been investigated, including without limitation Co (cobalt), Mn (manganese), Sn (tin) and Ti (titanium) alloy oxides. These alloy oxides have been studied at a number of different Ru: metal ratios, for example 1:1, 1:10, 1:20, and 1:100 Ru:metal ratios.

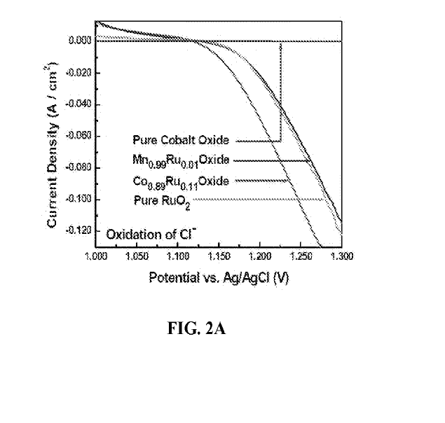

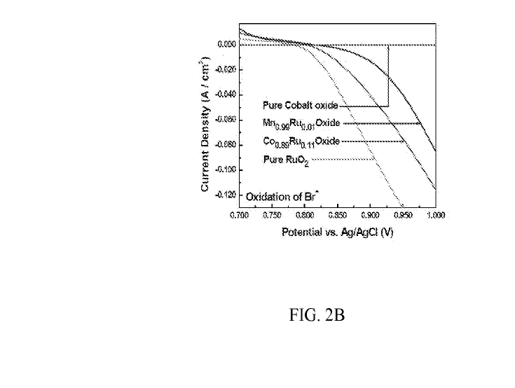

FIG. 2A illustrates test results of electrocatalytic activity of alloy oxide electrodes for chloride oxidation. FIG. 2B illustrates test results of electrocatalytic activity of alloy oxide electrodes for bromide oxidation. These electrodes were fabricated using known methods as described above. Among the inexpensive transition metals with which the RuO₂ has been alloyed, two transition metals, namely cobalt and manganese, yielded promising results in these studies.

FIGS. 2A and 2B show that pure cobalt oxide exhibits a negligible current density, but once it is alloyed with Ru to become Co0.89Ru0.11Ox, the catalytic activity for chlorine exceeds that of pure RuO₂, as seen in FIG. 2A, and the catalytic activity for bromine approaches that of pure RuO₂, as seen in FIG. 2B.

In FIGS. 2A and 2B, linear sweep voltammetry polarization curves were measured to assess electrocatalytic activity. For the chlorine redox experiments illustrated in FIG. 2A, the voltage was swept from 1.0 V to 1.6 V at a rate of 10 mV s-1. For the bromine redox experiments illustrated in FIG. 2B, the voltage was swept from 0.7 to 1.4 V at a rate of 10 mV s-1.

The studies illustrated in FIGS. 2A and 2B thus show that Co-Ru and Mn-Ru alloy oxides can be synthesized that have very low precious metal content yet exhibit good catalytic activity and good stability in acidic electrolytes and halogen environments. In other words, a significant decrease of Ru metal content by alloying with inexpensive metals can be achieved without compromising catalytic activity or stability.

Further details are described in “Alloy Oxide Electrocatalysts for Regenerative Hydrogen-Halogen Fuel Cell,” by Sujit K. Mondal, Jason Rugolo, and Michael J. Aziz, in Materials Research Society Symposium Proceedings 1311, GG10.9 (2010). The contents of this reference are incorporated herein by reference in its entirety.

In some embodiments, half-cell measurements can be used to identify the most promising alloys. In one example of a half-cell measurement, the alloy of interest (for example, RuCo, RuMn, RuSn, or RuTi) may be used for the working electrode, and a Ag/Ag Cl reference electrode may be used. A Pt foil may be used as counter electrode, and HCl/Cl₂ may be used as electrolyte.

Using half-cell measurements, a number of alloy oxides with different Ru compositions were found to substantially reduce the precious metal loading in the electrode while maintaining catalytic activity comparable to commercially available DSAs.

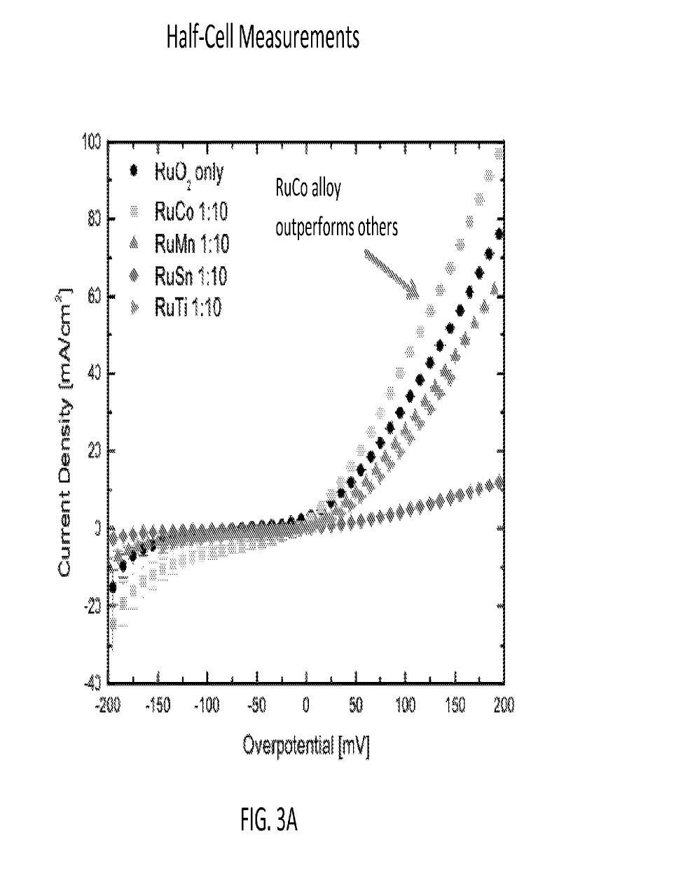

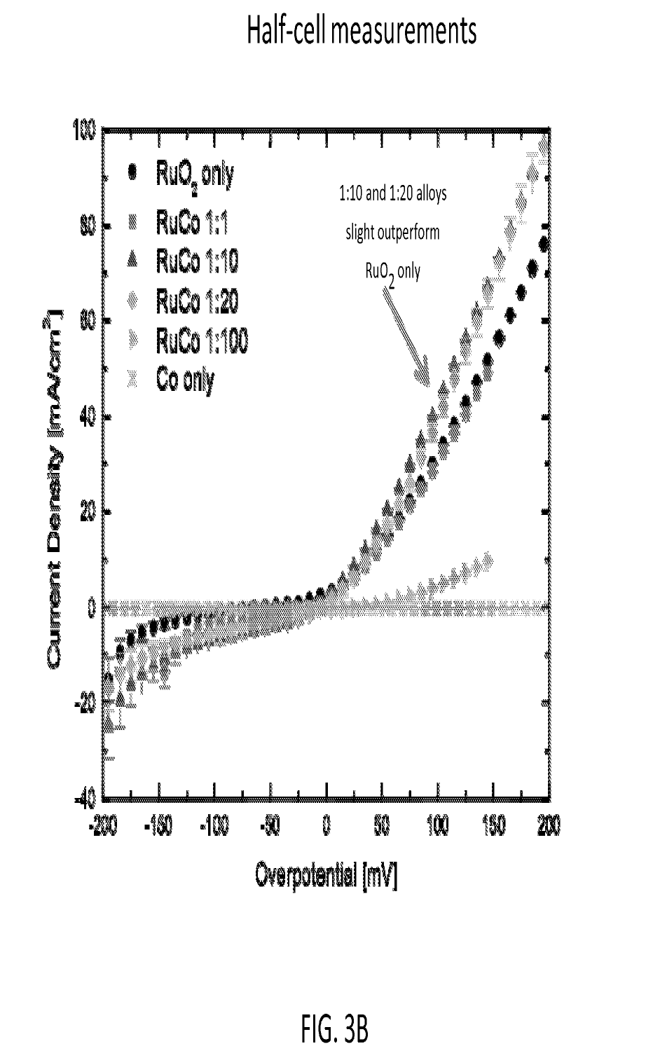

FIG. 3A illustrates half-cell measurements of electrode activity for a number of Ru-metal alloy oxides used in catalytic electrodes of regenerative HCl/Cl₂ fuel cells. The known preparation method for these electrodes differed slightly from the method used to make the electrodes of FIG. 2. FIG. 3A illustrates chloride oxidation and chloride reduction current densities as functions of overpotential for several different electrodes, namely electrodes that included oxides of alloys of ruthenium with cobalt, manganese, tin, and titanium. The Ru concentration in all four alloy oxides in FIG. 3A is 1:10.

FIG. 3A shows that the RuCo alloy performs exceptionally well, outperforming all other alloys. In fact, the RuCo alloy outperforms even RuO₂, as seen in FIG. 3A. Another alloy oxide demonstrating good catalytic activity at 1:10 Ru concentration is the manganese ruthenium oxide, which is shown in FIG. 3A to only slightly trail pure ruthenium oxide in catalytic activity.

FIG. 3B illustrates half-cell measurements of electrode activity for the RuCo alloy oxide at different Ru concentrations, namely 1:1 (50% ruthenium), 1:10 (10% ruthenium), 1:20 (5% ruthenium), and 1:100 (1% ruthenium). As seen in FIG. 3B, the 1:10 and 1:20 RuCo alloys slightly outperform pure RuO₂. The known preparation method for these electrodes differed slightly from the method used to make the electrodes of FIG. 2.

The measurements illustrated in FIG. 3B show that RuCo oxides in which the fraction of metal that is ruthenium is reduced down to about 5 percent can sustain excellent catalytic activity.

Cost-wise, it should be appreciated that the metal content in the above-disclosed alloy oxides entails a cost that is much lower than any conventional alloy oxide. Ruthenium costs more than $12,000/kg, whereas cobalt costs less than $300/kg, and manganese costs less than $80/kg.

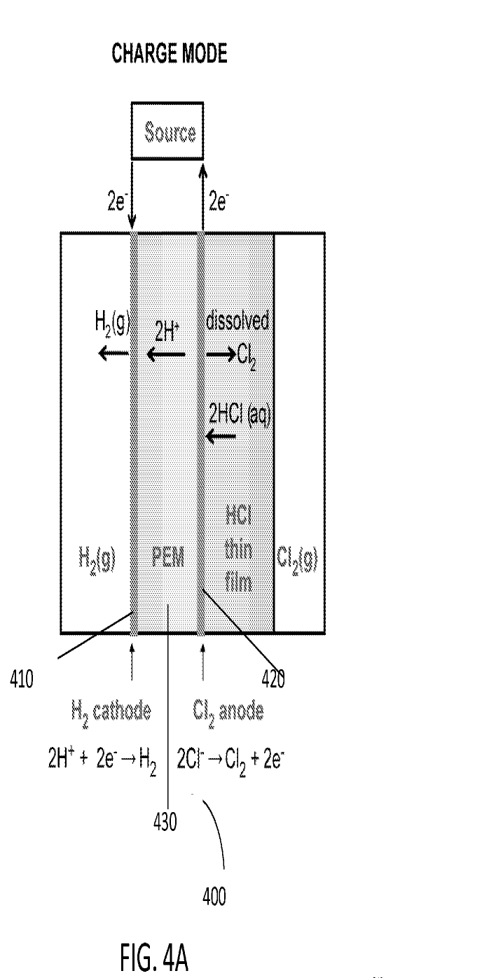

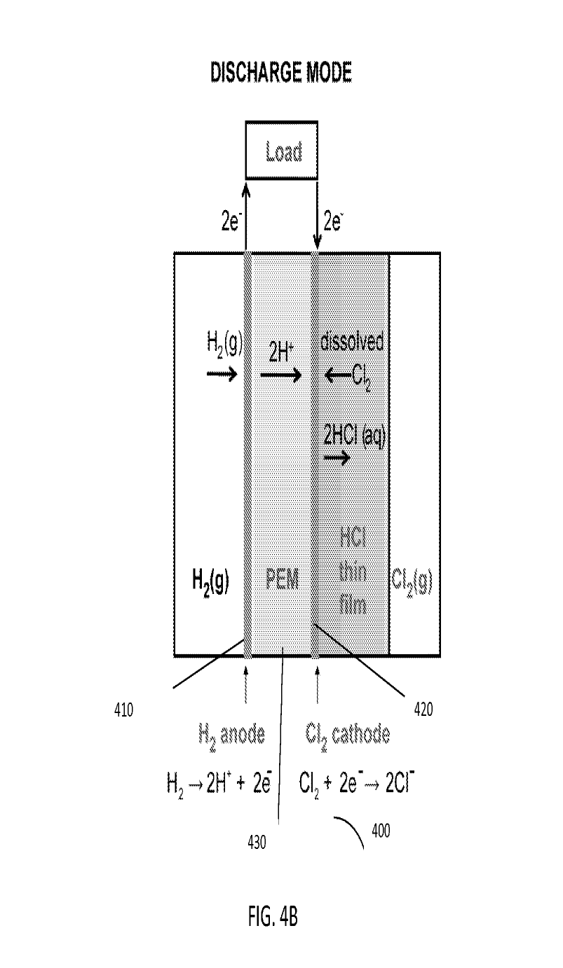

FIGS. 4A and 4B are schematic block diagrams of a fuel cell 400 that includes a catalytic electrode constructed in accordance with some embodiments of the present disclosure. In the illustrated embodiment, the fuel cell 400 is one type of a hydrogen-halogen regenerative fuel cell, namely a hydrogen-chlorine regenerative fuel cell.

In overview, the fuel cell 400 includes a hydrogen electrode 410, a halogen electrode 420, and a PEM (polymer electrolyte membrane or proton exchange membrane) 430 that electronically separates the electrodes 410 and 420 while allowing ions to pass to maintain charge balance.

FIG. 4A illustrates a charge mode of the hydrogen-chlorine regenerative fuel cell. In the charge mode, reduction reactions (2H⁺+2 e⁻→H₂) occur at the hydrogen electrode 410, while oxidation reactions (2Cl⁻→Cl₂+2e⁻) occur at the halogen electrode 420. Thus the hydrogen electrode 410 operates as a cathode while the chlorine electrode 420 operates as an anode.

FIG. 4B illustrates a discharge mode of the hydrogen-chlorine regenerative fuel cell. In the discharge mode, oxidation reactions (H₂→2H⁺+2 e⁻) occur at the hydrogen electrode 410, while reduction reactions (Cl₂+2e⁻→2Cl) occur at the halogen electrode 420. Thus the hydrogen electrode 410 operates as an anode, and the halogen electrode 420 operates as a cathode.

In the illustrated embodiment, the halogen electrode 420 is synthesized using ruthenium-metal alloy oxides described above, while conventional commercial electrodes are used for the hydrogen electrode 410.

While hydrogen-chlorine regenerative fuel cells have been illustrated in the exemplary embodiments, many other types of energy storage devices may use electrodes containing the ruthenium-metal alloy oxides disclosed above. For example, in some embodiments chlor-alkali cells as used in the chlor-alkali industry may include catalytic electrodes synthesized using the above-disclosed complex oxides.

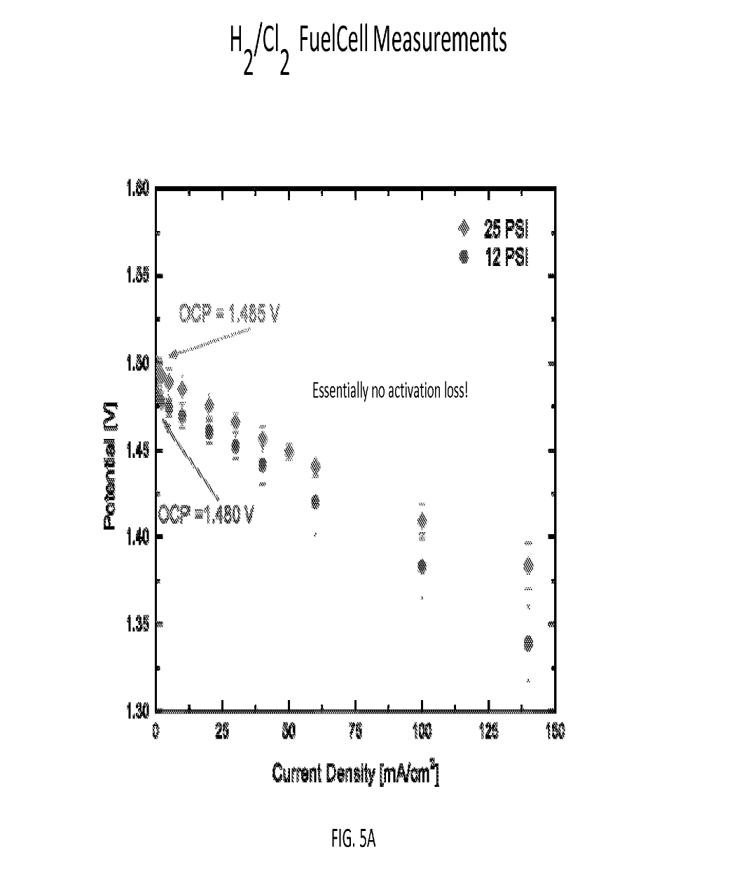

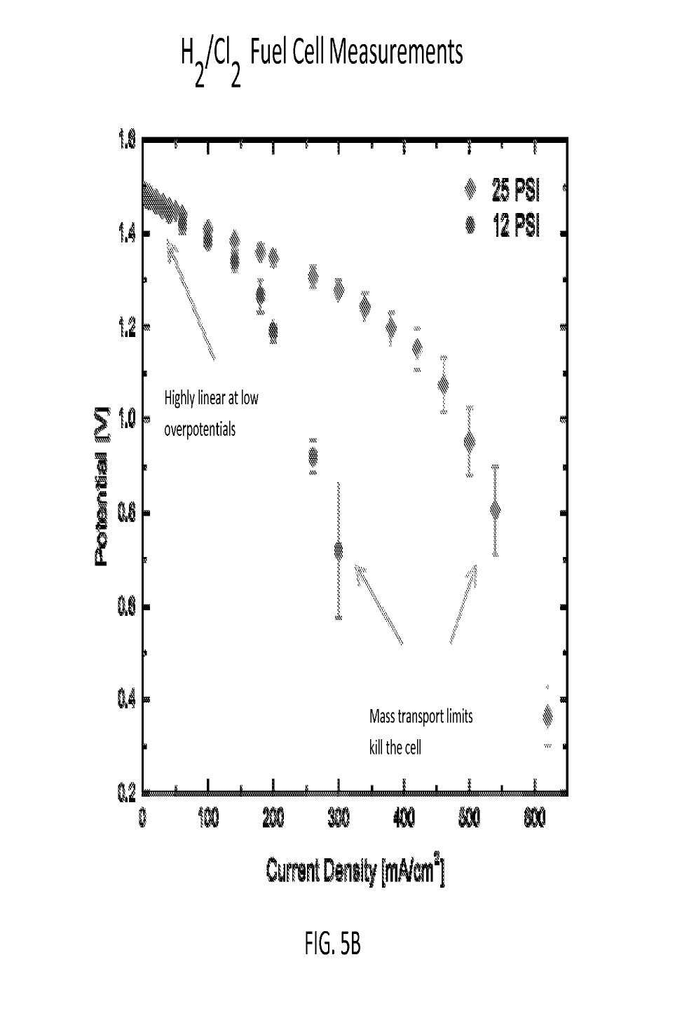

FIG. 5A illustrates fuel cell measurements of voltage versus current density for a H₂/Cl₂ regenerative fuel cell, at a current density range from 0 to about 150 mA/cm². FIG. 5B illustrates the same H₂/Cl₂ fuel cell measurements as FIG. 5A, but for a current density range that has been extended to about 650 mA/cm².

FIGS. 5A and 5B illustrate the drop in voltage, as more current density is drawn from the fuel cell. In an ideal electrochemical device, such voltage drop would be zero. In practice, there are at least four sources of loss in a hydrogen-halogen fuel cell 400 illustrated in FIGS. 4A and 4B. They include halogen activation loss; hydrogen activation loss; ohmic resistive loss in the electrolyte; and mass transport loss due to halogen mass transport limitations. The voltage drop shown in FIGS. 5A and 5B results from the addition of all four types of loss.

Typically, ohmic resistive losses are linear, i.e. a straight line in the voltage v. current density curve. Activation losses, on the other hand, have a markedly curved shape in a voltage v. current plot, with a steep initial slope that flattens out rapidly. Mass transport losses, on the other hand, start off with a relatively flat slope, and steepen towards the end of the current density range. The shape of the voltage drop curve shown in FIG. 5A thus shows that there is essentially no activation loss, and the voltage drop is mainly ohmic resistive loss.

As seen in FIG. 5B, the H₂/Cl₂ fuel cell measurements are highly linear at low overpotentials. As the current density increases, mass transport losses become more significant, eventually seriously compromising the operation of the fuel cell.

In sum, alloy oxides with very low precious metal content that exhibit good catalytic activity and good stability in acidic electrolytes and halogen environments have been disclosed. The complex oxide electrodes disclosed above may be useful in a wide range of energy storage devices, fuel cells, and electrolysis cells including without limitation chlor-alkali cells.

These complex oxide electrodes can be very useful in the chlor-alkali industry and in the energy storage industry. In the chlor-alkali industry, the cost of chlorine production could be significantly lowered. In the energy storage industry, the cost of energy storage could be significantly lowered.

While certain embodiments have been described of systems and methods relating to complex oxides for catalytic electrodes, it is to be understood that the concepts implicit in these embodiments may be used in other embodiments as well. In the present disclosure, reference to an element in the singular is not intended to mean “one and only one” unless specifically so stated, but rather “one or more.” All structural and functional equivalents to the elements of the various embodiments described throughout this disclosure, known or later come to be known to those of ordinary skill in the art, are expressly incorporated herein by reference.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

Nothing that has been stated or illustrated is intended to cause a dedication of any component, step, feature, object, benefit, advantage, or equivalent to the public. While the specification describes particular embodiments of the present disclosure, those of ordinary skill can devise variations of the present disclosure without departing from the inventive concepts disclosed in the disclosure.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the inventive subject matter in the present disclosure is not entitled to antedate such publication by virtue of prior invention.

What is claimed is:

1. A catalytic electrode comprising:
a substrate; and
a complex oxide deposited on the substrate, the complex oxide including ruthenium, oxygen, and at least one other metal;
wherein the percentage of metal content that is ruthenium is less than about 20 percent; and
wherein the percentage and the other metal are selected so as to allow the electrode to maintain sufficient electrocatalytic activity during a redox reaction at the electrode; and
wherein the other metal does not exceed the ruthenium in cost.

2. The electrode of claim 1, wherein the other metal is a transition metal.

3. The electrode of claim 1, wherein the other metal is cobalt, and wherein the percentage of the metal content that is ruthenium is about 5 atomic percent or less.

4. The electrode of claim 1, wherein the other metal is cobalt, and wherein the percentage of the metal content that is ruthenium is about 10 atomic percent or less.

5. The electrode of claim 1, wherein the other metal is manganese, and wherein the percentage of the metal content that is ruthenium is about 10 atomic percent or less.

6. The electrode of claim 1, wherein the other metal comprises one of: Sn, Pb, Fe, Ni, Cu, and Zn.

7. The electrode of claim 1, wherein the substrate comprises niobium.

8. The electrode of claim 1, wherein the complex oxide is nano-structured.

9. The electrode of claim 1, wherein the complex oxide is a composite of more than one phase of metal oxide or metal alloy oxide.

10. The electrode of claim 1, wherein the complex oxide is an oxide of an alloy that includes the ruthenium and the other metal.

11. The electrode of claim 1, wherein the electrode is an anode; and wherein the redox reaction comprises oxidation of a halide.

12. The electrode of claim 1, wherein the electrode is a cathode, and the redox reaction comprises reduction of a halogen.

13. The catalytic electrode of claim 1, wherein the substrate has a thickness less than about 150 microns.

14. A fuel cell comprising the electrode of claim 1.

15. The fuel cell of claim 14, comprising a regenerative fuel cell.

16. The fuel cell of claim 15, comprising one of: a halogen fuel cell; and a hydrogen-halogen fuel cell.

17. A flow battery comprising the electrode of claim 1.

18. The flow battery of claim 17, comprising one of: a halogen flow battery; and a hydrogen-halogen flow battery.

19. An electrolysis cell comprising the electrode of claim 1.
